(19) United States
(12) Patent Application Publication
(10) Pub. No.: US 2008/0009328 A1
(43) Pub. Date: Jan. 10, 2008

(54) SLEEP MODE OPTIMIZATION FOR REDUCING BATTERY LIFE IN BROADBAND WIRELESS COMMUNICATION DEVICES

(75) Inventor: Murali Narasimha, Zurich, IL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., Libertyville, IL (US)

(21) Appl. No.: 11/428,703

(22) Filed: Jul. 5, 2006

(51) Int. Cl. H04B 1/38

(52) U.S. Cl. 455/574

(57) ABSTRACT

A method in a wireless communication terminal including transmitting a sleep mode request message (400), indicating information about a sleep mode ratio, for example, decimal and integer values, in the sleep mode request message, wherein the sleep mode ratio is formed by a ratio of successive sleep window durations, which are separated by a monitoring interval during which the wireless communication terminal monitors a channel.

### FIELD OF THE DISCLOSURE

The present disclosure relates generally to wireless communications, and more particularly to improving sleep mode performance in adaptive wireless communication terminals, for example, 802.16e terminals, and corresponding methods.

### BACKGROUND

The recently completed IEEE 802.16e protocol standard is an alternative to traditional cellular standards such as UMTS and CDMA. 802.16e is also the core technology on which WiMAX was developed. WiMAX is a standards-based wireless communication technology providing broadband connections over long distances. WiMAX is suitable for many applications including “last mile” broadband connections, hotspots and cellular backhaul, and high-speed enterprise connectivity for business.

As in other wireless communication technologies, the 802.16e protocol allows the mobile station (MS) to sleep for some duration when the MS is not sending or receiving packets. 802.16e however specifies signaling that the MS and BS must perform before the MS can enter sleep mode. Generally, the MS must periodically monitor a negotiated number of frames to check for traffic indications, for example, a page on a paging channel. The duration between monitoring intervals is called the sleep window. The MS exits sleep mode and enters normal operating mode if it receives a traffic indication during a monitoring interval.

The energy consumption during sleep mode in 802.16e devices is higher than the energy consumption of current cellular standard compliant terminals operating in idle mode. Under the current 802.16e standard, the sleep window starts at T₀ and is doubled after each listening interval until it reaches a maximum sleep duration, Tₘₐₓ. The sleep window, T, is currently defined as Tₖ=min(T₀×2^{k}, Tₘₐₓ). Tₘₐₓ may be expressed as T₀×2^{k}^{ₘₐₓ} where kₘₐₓ is an integer. For the case where the average packet burst arrival rate is 0.1 packets/sec, T₀=80 ms and kₘₐₓ=3, the average (expected) paging delay is 0.6 s. If kₘₐₓ=4, the average paging delay is 1.2 s. If a MS requires an average paging delay of 1 s, it must use kₘₐₓ=3, since k must be an integer. This value of k however causes the MS to monitor for traffic indications more frequently than necessary to satisfy the desired average paging delay of 1 s. The MS thus expends more energy than necessary, which has an adverse affect on battery performance.

The various aspects, features and advantages of the disclosure will become more fully apparent to those having ordinary skill in the art upon careful consideration of the following Detailed Description and the accompanying drawings described below. The drawings may have been simplified for clarity and are not necessarily drawn to scale.

### BRIEF DESCRIPTION OF THE DRAWINGS

FIG. 1 is a wireless communication system.

FIG. 2 is a wireless communication terminal.

FIG. 3 illustrates a sleep mode cycle.

FIG. 4 is an illustrative format for a sleep-request message.

FIG. 5 is a process flow diagram.

### DETAILED DESCRIPTION

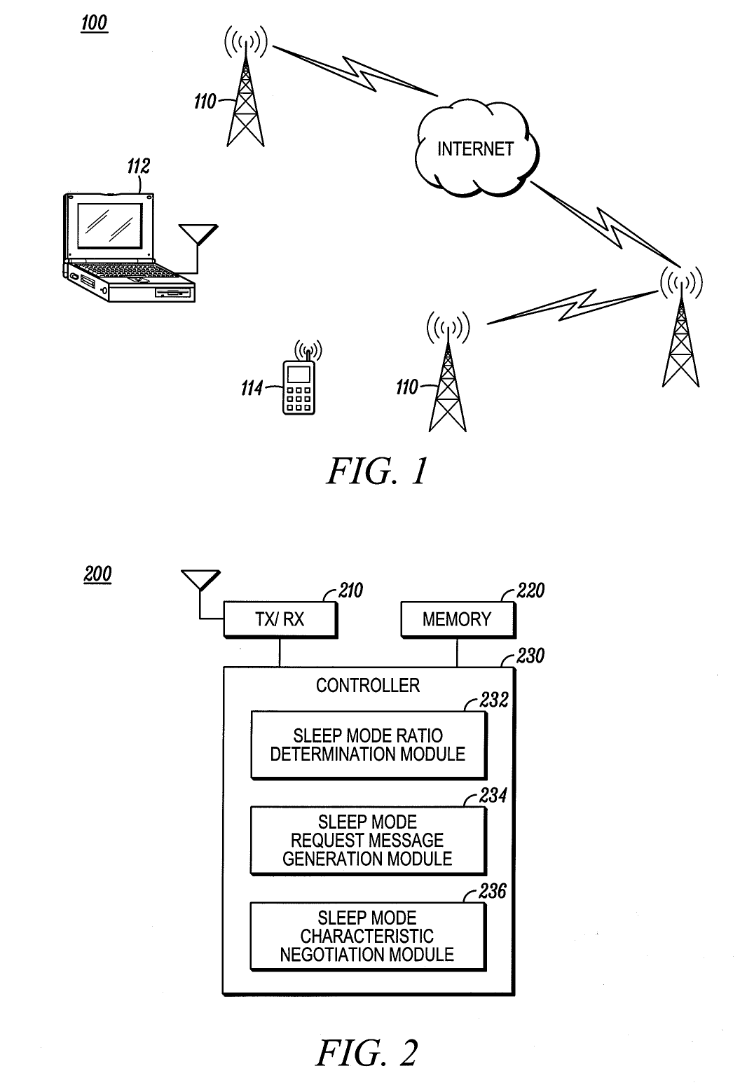

In FIG. 1, an exemplary wireless communication system 100 comprises one or more base stations 110 that communicate with one or more user terminals, for example, fixed base terminal 112 and/or mobile terminal 114. The exemplary base station may be based on the 802.16 protocol, for example, WiMax or it may be based on some other wireless communication protocol. The base stations 110 are communicably coupled to the Internet or to another network, either directly or by intermediary infrastructure entities. In other embodiments, the base stations 110 are compliant with some other wireless communication protocol.

FIG. 2 is an exemplary wireless communication terminal or device 200 comprising a wireless transceiver 210 communicably coupled to a controller 230 having associated memory 220. In the exemplary embodiment, the transceiver is an 802.16e based transceiver capable of communicating with an 802.16e compliant base station. In other embodiments, the transceiver complies with some other communication protocol. The wireless terminal also includes user inputs and outputs, for example, audio, keypad, video, among other inputs and outputs not illustrated but known generally to those having ordinary skill in the art.

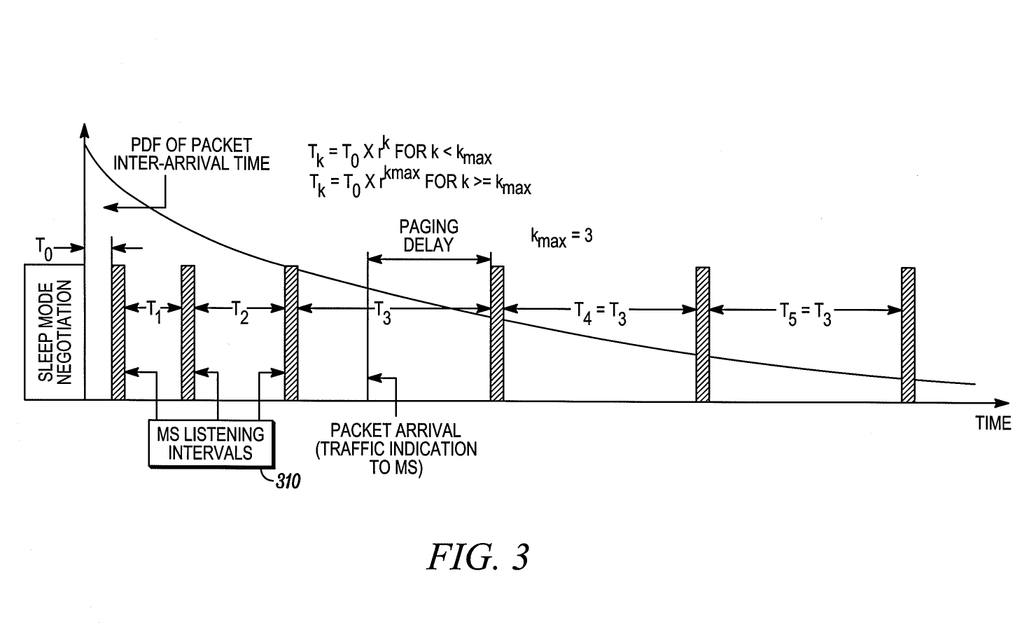

The terminal 200 is generally capable of operating in a sleep mode when the terminal is not sending or receiving packets. Sleep mode operation is useful in mobile terminal applications to reduce battery power consumption. Sleep mode operation is characterized by monitoring a channel, for example, a paging channel, during periodic monitoring intervals separated by corresponding sleep windows. FIG. 3 graphically illustrates sleep mode operation wherein the terminal or mobile station (MS) listens or monitors during intervals 310 separated by corresponding, sleep windows having relatively long durations.

In some embodiments, the sleep window durations, Tₖ, increase over an early portion or phase of the sleep mode cycle and then assume a fixed duration over a later phase of the sleep mode cycle. In FIG. 3, for example, the sleep windows T₁, T₂, T₃ have increasing durations, and sleep windows T₃-T₅ are of equal duration. Aspects of the disclosure are applicable to wireless communication terminals that operate in sleep modes having sleep window durations that increase or decrease over an early phase of the sleep mode cycle and then assume a fixed duration over a later phase of the sleep mode cycle, without regard for the communication protocol under which the terminals operate, as discussed more fully below.

A sleep mode factor or ratio, r, is formed by a ratio of successive sleep window durations separated by a monitoring interval during which the wireless communication terminal monitors a channel. In embodiments where the sleep mode ratio changes during a portion of the sleep mode cycle, the ratio will be non-unity. The sleep mode ratio is unity where the ratio is formed of sleep windows having equal durations. In FIG. 3, the generalized equation for T is

Tₖ=min(T₀×r^{k}, Tₘₐₓ) where r>0 is a real number. Here, r is the sleep mode factor or ratio and k is the index (integer) of the sleep window.

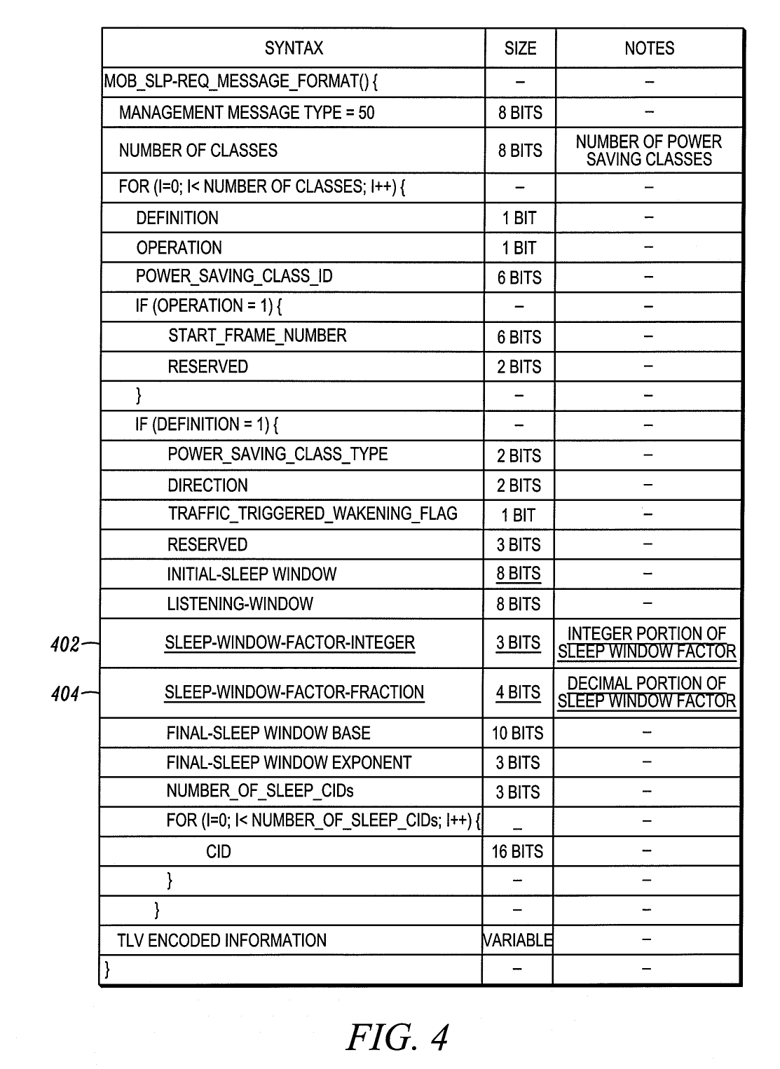

In one embodiment, the wireless communication terminal transmits a sleep mode request (uplink) message to the network indicating information about the sleep mode ratio. In 802.16 networks, a sleep mode request message is used to request the definition and/or activation of certain Power Save Classes of types 1, 2, and 3. FIG. 4 illustrates an 802.16 Sleep-Request (MOB_SLP_REQ) message format. In one embodiment, the information about the sleep mode ratio includes indicating an integer portion and/or a decimal portion of the sleep mode ratio. Particularly, at 402 in FIG. 4, a 3-bit “sleep-window-factor-integer” indicates an integer portion of the sleep factor or ratio, and at 404 a 4-bit “sleep-window-factor-fraction”indicates a decimal portion of the ratio. In one 802.16 application, the integer and decimal portions of the sleep window factor apply only to Power Saving Class type I. In other embodiments, the sleep mode request message characterizes the sleep mode ratio in terms other than it integer and decimal terms.

Specifying integer and decimal portions of the sleep mode ratio permits accommodating average paging delay requirements of the wireless communication terminal with more precision, thus reducing unnecessary traffic indication monitoring by the terminal and reducing unnecessary battery power consumption. Thus the sleep mode ratio, r, between successive sleep windows may generally assume non-integer values. In one embodiment, the ratio, r, between successive sleep windows during the portion of the sleep mode cycle where the sleep window duration changes assumes a value within one of the following ranges:

0<r<1

1<r<2

r>2

For 0<r<1, the successive sleep window durations decrease. For r>1, the sleep mode window durations increase.

In one embodiment, the sleep more factor or ratio is changed dynamically, for example, from one sleep mode cycle to the next. More particularly, a wireless communication terminal may operate in a first sleep mode, which is characterized by monitoring a channel during periodic monitoring intervals separated by corresponding sleep windows wherein a ratio of successively increasing sleep window durations forms the sleep mode ratio as discussed above. At some point the terminal exits the first sleep mode, for example, upon receiving a page. Thereafter, eventually, the terminal will likely re-enter sleep mode (referred to as the second or subsequent sleep mode). Generally, the sleep mode ratio for the first sleep mode may be different than the sleep mode ratio for the second sleep mode. The change in sleep mode ratios between different sleep mode cycles is distinguished from the change in the sleep mode ratio that occurs during a particular sleep mode when the sleep windows assume the same duration, for example, sleep mode duration T₃-T₅ in FIG. 3.

Generally, the sleep mode ratio or factor may be negotiated between the base station and the wireless communication terminal. In FIG. 2, the wireless terminal controller 230 includes a sleep mode characteristic determination module 232 for determining the sleep mode ratio and possibly other characteristics of the sleep mode. In FIG. 4, for example, the wireless communication terminal may suggest or indicate a new Power Saving Class definition by setting the “Definition” bit in the Sleep-Request message. In FIG. 2, the wireless terminal controller includes a sleep mode request message generation module for generating a sleep mode request message including sleep mode ratio information, for example, decimal and integer information discussed above. The message is communicated to the network by the transceiver 210. The controller also includes a sleep mode characteristic negotiation module 236 for negotiating sleep mode characteristics with the base station.

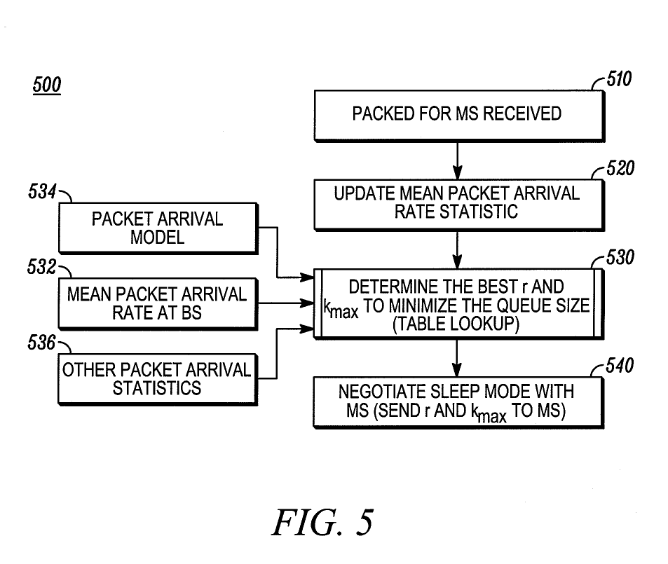

Alternatively, the base station may initialize the negotiation or it may dictate what ratio the wireless terminal uses when entering sleep mode. The base station may compute a sleep mode ratio based on network loading conditions. For example, the base station may require that a particular terminal wake up more frequently if traffic is heavy, thereby reducing the queuing of packets in the base station for the particular terminal. Network loading conditions may be characterized in part based on a mean packet arrival rate statistic, among other statistics, for terminals in the network. In the process flow diagram 500 of FIG. 5, more particularly, at 510, a base station receives packets for a wireless communication terminal, for example, a mobile station (MS). At 520, the base station computes and/or updates a mean packet arrival rate statistic for the MS. At 520, the base station determines a sleep mode factor and other characteristics of the sleep mode cycle for the particular terminal based on the mean packet arrival statistic 532. The sleep mode factor and other characteristics may also be based on a packet arrival model 534 and on other packet statistics 536, discussed further below.

The packet arrival model is a statistical description of the packet arrivals at the base station for the MS. For example, the packet arrival model could be based on a Poisson process wherein the probability of n packets arriving over a duration τ is given by

$${e}^{- λ τ} \frac{{( λ τ )}^{n}}{n !} ,$$

where λ represents the mean packet arrival rate. Other packet statistics could include the mean packet arrival rate and the standard deviation of the packet arrival rate.

In FIG. 5, at 540, the base station negotiates the sleep mode with the wireless terminal, or alternatively the base station may dictate this information to the terminal. Generally, the process of FIG. 5 may be performed by the base station for multiple terminals in the network, wherein a different sleep mode factor is potentially assigned or negotiated with each terminal. In other embodiments, the base station may determine the sleep mode ratio based on a target average paging delay.

The sleep mode ratio may also be based on other factors that may or may not depend on the entity that determines the sleep mode ratio or other characteristics. The wireless communication terminal may, for example, determine and request a change of the sleep mode ratio based on a particular service subscribed to, for example, PTT, by the wireless communication terminal. The sleep mode ratio may also be based upon the strength of a signal received (e.g., RSSI) by the wireless communication terminal, or upon an uplink data rate. The base station or terminal may determine a sleep mode ratio based upon an impending handover of the wireless communication terminal from one base station to another. For example, the terminal may change the sleep mode ratio when the terminal determines that a handoff is necessary or likely so that that terminal can monitor the channel more frequently. A new serving base station may decrease the sleep window after a handoff to enable the new serving base station to send the terminal data queued up prior to or during the handoff. The base station or terminal may also determine the sleep mode ratio based on one or more of the time of day, day of week, geographical location of the terminal.

While the present disclosure and the best modes thereof have been described in a manner establishing possession and enabling those of ordinary skill to make and use the same, it will be understood and appreciated that there are equivalents to the exemplary embodiments disclosed herein and that modifications and variations may be made thereto without departing from the scope and spirit of the inventions, which are to be limited not by the exemplary embodiments but by the appended claims.

What is claimed is:

1. A method in a wireless communication terminal, the method comprising:
transmitting a sleep mode request message,
indicating, in the sleep mode request message, information about a sleep mode ratio;
the sleep mode ratio is formed by a ratio of successive sleep window durations, which are separated by a monitoring interval during which the wireless communication terminal monitors a channel.

2. The method of claim 1, the sleep mode ratio is formed by a ratio of successive and unequal sleep window durations.

3. The method of claim 1, indicating in the sleep mode request message the information about the sleep mode ratio includes indicating an integer portion of the sleep mode ratio.

4. The method of claim 1, indicating in the sleep mode request message the information about the sleep mode ratio includes indicating a decimal portion of the sleep mode ratio.

5. The method of claim 1, indicating in the sleep mode request message information about the sleep mode ratio includes indicating integer and decimal portions of the sleep mode ratio.

6. A method in a wireless communication terminal, the method comprising:
operating in a first sleep mode characterized by monitoring a channel during periodic monitoring intervals separated by corresponding sleep windows wherein a ratio of successively increasing sleep window durations forms a sleep mode ratio;
exiting the first sleep mode;
operating in a second sleep mode after exiting the first sleep mode,
wherein the sleep mode ratio for the first sleep mode is different than a sleep mode ratio for the second sleep mode.

7. The method of claim 6, changing the sleep mode ratio based on a service subscribed to by the wireless communication terminal.

8. The method of claim 6, changing the sleep mode ratio based on strength of a signal received by the wireless communication terminal.

9. The method of claim 6, changing the sleep mode ratio based on an impending handover of the wireless communication terminal from one base station to another base station.

10. The method of claim 6, changing the sleep mode ratio based on an uplink data rate.

11. The method of claim 6, changing the sleep mode ratio based on a target average paging delay.

12. The method of claim 6,
transmitting a sleep mode request message,
indicating, in the sleep mode request message, sleep mode ratio information.

13. A method in a wireless communication terminal, the method comprising:
monitoring a channel during periodic monitoring intervals separated by corresponding sleep windows during sleep mode;
increasing a duration of the sleep windows from an initial duration to a maximum duration,
wherein a ratio, r, between successive sleep windows is 1<r<2 and r>2.

14. The method of claim 13, increasing the duration of the sleep windows from the initial duration to the maximum duration, wherein the ratio, r, between successive sleep windows is a non-integer value.

15. The method of claim 13, the wireless communication terminal is an 802.16e terminal, operating the wireless communication terminal in a Power Save Class type I mode.

16. The method of claim 13, dynamically changing the ratio, r, between successive sleep modes.

17. A method in a wireless communication network infrastructure entity, the method comprising:
negotiating a sleep mode ratio with a wireless communication terminal operating in a sleep mode,
the sleep mode characterized by periodic monitoring intervals each separated by a corresponding sleep window wherein the sleep mode ratio is a ratio of successive sleep windows of unequal duration.

18. The method of claim 17,
determining an initial sleep mode ratio for use by the wireless communication terminal operating in a sleep mode,
negotiating an ultimate sleep mode ratio with the wireless communication terminal.

19. The method of claim 17,
queuing packet data for the wireless communication terminal,
determining the sleep mode ratio based on a queue size of the packet data.

20. The method of claim 17, determining the sleep mode ratio based on a target average paging delay.

21. The method of claim 17, determining the sleep mode ratio based on a mean packet arrival rate.

22. The method of claim 17, negotiating different sleep mode ratios with different wireless communication terminals.
